(19) United States
(12) Patent Application Publication
(10) Pub. No.: US 2013/0280498 A1
(43) Pub. Date: Oct. 24, 2013

(54) METHOD FOR PRODUCING THREE-DIMENSIONAL IMAGE FORMATION OBJECT, AND THREE-DIMENSIONAL IMAGE FORMATION SHEET

(71) Applicant: CASIO COMPUTER CO., LTD., Tokyo (JP)

(72) Inventors: Yuji HORIUCHI, Tokyo (JP); Satoshi KIMURA, Tokyo (JP)

(73) Assignee: CASIO COMPUTER CO., LTD., Tokyo (JP)

(21) Appl. No.: 13/865,020

(22) Filed: Apr. 17, 2013

(30) Foreign Application Priority Data
Apr. 19, 2012 (JP) 2012-095310

(51) Int. Cl. B44F 7/00; B32B 37/00

(52) U.S. Cl. CPC B44F 7/00; B32B 37/0076
USPC 428/195.1; 156/227

(57) ABSTRACT

A method for producing a three dimensional (3D) image formation object as a specific product using a thermally expandable sheet on which an intended 3D image is formed is described. The method sets first and second regions with a first processing line as a borderline on the first side, forms a first image for obtaining a 3D image in the first region, prints information on the second region, processes the 3D image formation sheet to fold the sheet along the first processing line, and adheres a third region which is on a second side of the 3D image formation sheet and corresponding to the second region and a fourth region which is on the second side of and corresponding to the fourth region to each other. This completes the 3D image formation object in which the first and second regions have a front/back relationship.

### CROSS-REFERENCE TO RELATED APPLICATIONS

This application is based upon and claims the benefit of priority from the prior Japanese Patent Application No. 2012-95310 filed on Apr. 19, 2012, the entire contents of which are incorporated herein by reference.

### FIELD

The present invention relates to a three dimensional (3D) image forming method and a 3D image formation sheet. The present invention especially relates to a method for producing a 3D image formation object, which method produces the 3D image formation object by selectively expanding a thermally expandable sheet, and relates to a 3D image formation sheet applied to the 3D image formation object producing method.

### BACKGROUND

Heretofore, there has been known a thermally expandable sheet (or thermally foamable sheet) where a thermally expandable layer (or thermally foamable layer) is formed on one surface of a substrate sheet, which layer includes foamable microcapsules to expand by applying heat. By printing an image pattern having a high light absorption capacity on the thermally expandable sheet and then irradiating the sheet with light including infrared light (far-infrared light in a broad sense), the thermally expandable layer in a region which corresponds to the image pattern is selectively heated to expand, and a three dimensional (3D) image corresponding to the image pattern can be formed on the one surface of the substrate sheet.

As such 3D image forming technique, for example, Japanese Patent Application Laid-Open Publication No. shou 64-28660 describes a method which forms a print image with black toner or ink having a high light absorption capacity on a front surface of a thermally expandable sheet, namely, a surface of a thermally expandable layer, or a back surface of the sheet, namely, a surface of a substrate sheet, and irradiates the print image with light by a halogen lamp or the like, so that the print image absorbs the light to produce heat, and the heat is applied to microcapsules included in a thermally expandable layer in a region which corresponds to the print image, and thereby microcapsules expand to form a 3D image.

Moreover, for example, Japanese Patent Application Laid-Open Publication No. 2001-150812 describes a method which forms a color image and the like on a front surface of a thermally expandable sheet, namely a surface of a thermally expandable layer, and forms a light absorption pattern composed of a shading image correspondingly to a design and the like of the color image on the front surface, on a back surface of the sheet, namely a surface of a substrate sheet. The method then irradiates the back surface of the thermally expandable sheet with light. This produces heat corresponding to shading of the light absorption pattern to control an expansion of a thermally expandable layer, and thereby adjusts a height of a raised portion of the 3D image.

By the abovementioned 3D image forming method, the 3D image where the thermally expandable layer selectively expands so that a raised portion is made correspondingly to the print image or the color image formed on the thermally expandable sheet may be obtained.

However, there has been only a proposal to set the thermally expandable sheet in a casing trim or picture frame for display, on which sheet the 3D image is formed, or to attach such sheet as a decoration. In other words, there has not been a proposal about what kind of product/article the 3D image is actually adapted/applied to, or a proposal about how the 3D image is adapted/applied to the product/article, in addition to framing and displaying.

### SUMMARY

The present invention is made in view of such circumstances, and an object of the present invention is to provide a three dimensional (3D) image forming method for producing a specific product using a thermally expandable sheet on which an intended 3D image is formed, and to provide a 3D image formation sheet to which the 3D image forming method is successfully applied.

To solve the abovementioned problem and achieve the object of the present invention, according to the first aspect of the present invention, there is provided a method for producing a 3D image formation object including: setting a first region and a second region with a first processing line as a borderline between the first and second regions on a first side of a 3D image formation sheet; forming a first image for obtaining a 3D image on the first region and printing information on the second region; and processing the 3D image formation sheet to fold the sheet along the first processing line and adhering a third region and a fourth region to each other, the third region being on a second side of the 3D image formation sheet and corresponding to the first region, and the fourth region being on the second side and corresponding to the second region.

Preferably, in the 3D image forming method, the 3D image formation sheet includes a continuous substrate sheet in which the first and second regions are repeatedly set in a predetermined order, and at an arbitrary timing at least before the folding processing of the 3D image formation sheet, the substrate sheet is cut into a unit size each including the first and second regions, and then the 3D image formation object is produced.

Preferably, the 3D image forming method further includes: setting a second processing line as a borderline which divides the first side except the second region into the first region and a fifth region on the first side of the 3D image formation sheet; forming intended information in the fifth region; and processing the 3D image formation sheet to fold the sheet along the second processing line so that the first and fifth regions face each other.

Preferably, the 3D image forming method further includes: forming a plurality of processing objects by the folding processing along the first processing lines by which the first and second regions face each other, arranging the processing objects so that directions of the first processing lines are aligned with one another, and adhering the third and fourth regions of the neighboring processing objects to each other, and producing the 3D image formation object including an assembly in which the processing objects exist continuously.

Preferably, the 3D image forming method further includes: repeatedly setting the first and the second regions with the first processing lines as the borderlines in the predetermined order; folding the 3D image formation sheet along the first processing lines to make mountain folds and valley folds alternately so that the first and second regions face each other; and adhering the third and fourth regions to each other to produce the 3D image formation object including an assembly in which a state that the neighboring first and second regions face each other and a state that the neighboring first and second regions have a front/back relationship are alternately repeated.

According to the second aspect of the present invention, there is provided a 3D image formation sheet including: a substrate sheet; a first region which is set on a first side of the substrate sheet and in which a first image for obtaining a 3D image is formed; a second region which is set on the first side of the substrate sheet and in which information is printed; a third region which is on a second side of the substrate sheet and corresponds to the first region; and a fourth region which is on the second side of the substrate sheet, corresponds to the second region, and in which an adhesive layer is formed, wherein the first and second regions are set across a first processing line as a borderline.

Preferably, in the 3D image formation sheet, the substrate sheet includes the first and second regions which are repeatedly set in a predetermined order, and further includes a cutting line for cutting the substrate sheet into a unit size including the first and second regions.

Preferably, the first and second regions are repeatedly set in a predetermined order on the substrate sheet, which sheet is processed to be folded along the first processing line so that a state in which the neighboring first and second regions face each other and a state in which the neighboring first and second regions have a front/back relationship are repeated.

Preferably, the 3D image formation sheet further includes: a fifth region on the first side of the substrate sheet, in which region information is printed, and the first and fifth regions are set across a second processing line as a borderline.

Thus, according to the present invention, a specific product as a 3D image formation object using a thermally expandable sheet on which an intended 3D image is formed can be proposed.

### BRIEF DESCRIPTION OF THE DRAWINGS

A more complete understanding of this application can be obtained when the following detailed description is considered in conjunction with the following drawings, in which:

FIGS. 1A to 1C are schematic configuration views illustrating a first embodiment of a three dimensional (3D) image formation sheet according to the present invention;

FIG. 2 is a flowchart illustrating an example of a method for producing a 3D image formation object according to a first embodiment;

FIGS. 3A to 3C are schematic top views illustrating a specific example in the method for producing the 3D image formation object according to the first embodiment;

FIGS. 4A to 4D are schematic cross sectional views illustrating a specific example in the method for producing the 3D image formation object according to the first embodiment;

FIGS. 5A and 5B are schematic views illustrating sheet processing steps in the method for producing the 3D image formation object according to the first embodiment;

FIGS. 6A and 6B are schematic perspective views illustrating a configuration where the 3D image formation sheet is applied to a product, in which sheet a 3D image is formed by the method for producing the 3D image formation object according to the first embodiment;

FIG. 7 is a schematic configuration view illustrating a variation of the 3D forming sheet according to the first embodiment;

FIGS. 8A and 8B are schematic configuration views illustrating the 3D image formation sheet according to a second embodiment of the present invention;

FIGS. 9A to 9C are schematic views illustrating sheet processing steps in the method for producing the 3D image formation object according to the second embodiment;

FIG. 10 is a schematic configuration view illustrating a variation of the 3D forming sheet according to the second embodiment;

FIGS. 11A to 11C are schematic views (part 1) illustrating sheet processing steps in the method for producing the 3D image formation object according to a third embodiment;

FIGS. 12A and 12B are schematic views (part 2) illustrating sheet processing steps in the method for producing the 3D image formation object according to the third embodiment;

FIGS. 13A to 13C are schematic configuration views illustrating a variation of the 3D forming sheet according to the third embodiment;

FIGS. 14A and 14B are schematic configuration views illustrating an example of a printing device by which a 3D image forming method of the present invention can be implemented;

FIG. 15 is a schematic configuration view illustrating an example of a print mechanism section in the printing device to which the 3D image forming method of the present invention can be applied; and

FIG. 16 is a function block diagram illustrating an example of the printing device to which the 3D image forming method of the present invention can be applied.

### DETAILED DESCRIPTION

Hereinafter, a method for producing a three dimensional (3D) image formation object, and a 3D image formation sheet, of the present invention will be concretely described showing embodiments.

### First Embodiment

### 3D Image Formation Sheet

The 3D image formation sheet to be used in the method for producing the 3D image formation object of the present invention will be firstly explained.

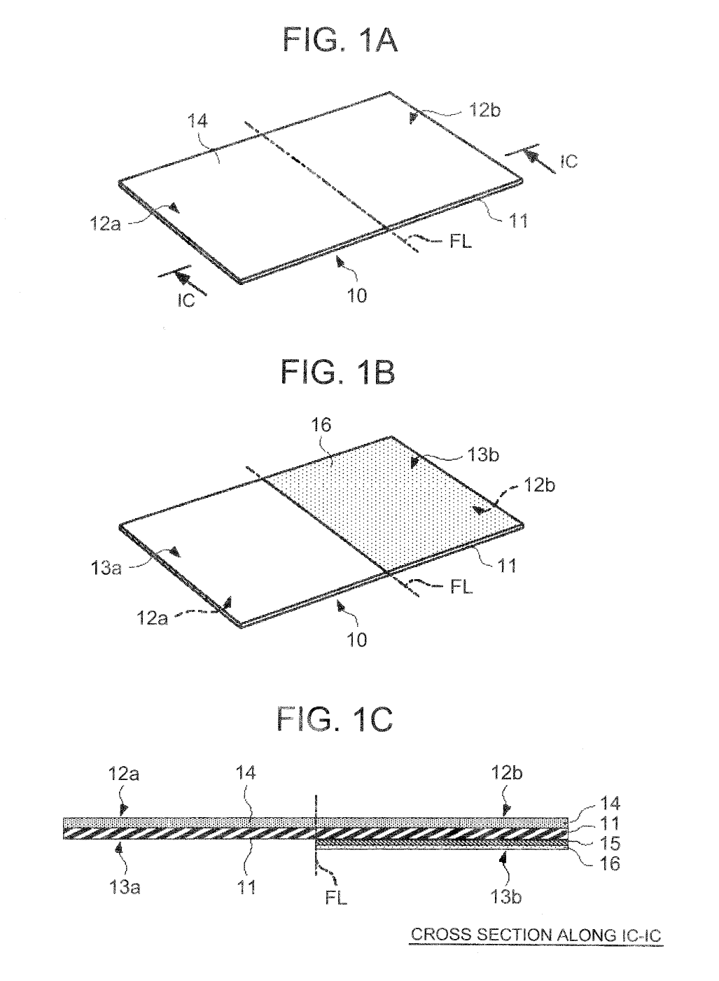

FIGS. 1A to 1C are schematic configuration views illustrating a first embodiment of the 3D image formation sheet of the present invention. FIG. 1A is a schematic perspective view illustrating a first side of the 3D image formation sheet according to this embodiment, and FIG. 1B is a schematic perspective view illustrating a second side of the 3D image formation sheet according to this embodiment. FIG. 1C is a cross sectional view illustrating a cross section along the line IC-IC shown in FIG. 1A. FIG. 1B illustrates the 3D image formation sheet which is rotated 180 degrees, namely, turned around upon the line IC-IC from the state shown in FIG. 1A. In FIG. 1B, a release sheet 16 is conveniently indicated by hatching for simple illustration.

As shown in FIGS. 1A to 1C, a 3D image formation sheet 10 according to the first embodiment of the present invention includes a substrate sheet 11. A sheet processing line FL divides each of a first side and a second side of the substrate sheet 11 into two regions. As the substrate sheet 11, a recording medium having a first side and a second side on each of which an image or characters can be directly printed.

Concretely, as shown in FIG. 1A for example, a 3D image forming surface 12a is set in a left area on a first side (upper side) of the substrate sheet 11 in the drawing, and a character information printing surface 12b is set in a right area on the same surface. In addition, as shown in FIG. 1B, a mirror image forming surface 13a is set in a left area on a second side (upper side) of the substrate sheet 11 in the drawing, and an adhesive surface 13b is set in a right area on the same surface. In other words, the 3D image forming surface 12a and the mirror image forming surface 13a have a front/back relationship via the substrate sheet 11, and the character information printing surface 12b and the adhesive surface 13b have a front/back relationship via the substrate 11.

The region which serves as the 3D image forming surface 12a (or the mirror image forming surface 13a) and the region which serves as the character information printing surface 12b (or the adhesive surface 13b) are adjacent to each other across the sheet processing line FL1 as a borderline, have the same shape as each other, and have a line symmetrical relationship with respect to the sheet processing line FL. Thus, the substrate sheet 11 to be used in the 3D image formation sheet 10 of this embodiment has the area twice that of the 3D image forming surface 12a (or the mirror image forming surface 13a) or the character information printing surface 12b (or the adhesive surface 13b).

As shown in FIGS. 1A and 1C, in the whole area (the 3D image forming surface 12a and the character information printing surface 12b) on the first side of the substrate sheet 11, a thermally expandable layer 14 including foamable microcapsules which expand by applying heat is provided. As shown in FIGS. 1B and 1C, as the adhesive surface 13b on the second side of the substrate sheet 11, an adhesive layer 15 is provided on the surface of the substrate sheet 11, and the release sheet 16 is provided to cover the adhesive layer 15, which sheet 16 can be removed so as to expose the adhesive layer 15 when the adhesive layer 15 is adhered to the intended object surface (the mirror image forming surface 13a).

In the 3D image formation sheet 10 of this embodiment having the abovementioned configuration, an arbitrary chromatic image is formed on the 3D image forming surface 12a on the first side of the substrate sheet 11, and a monochrome image corresponding to the chromatic image is formed on the mirror image forming surface 13a in the second side of the substrate sheet 11. In addition, arbitrary character information is formed (printed) on the character information printing surface 12b on the first side of the substrate sheet 11, and on the adhesive surface 13b on the second side, the adhesive layer 15 is preformed so as to be covered with the release sheet 16.

This embodiment describes the configuration of the adhesive surface 13b where the adhesive layer 15 is provided on the surface of the substrate sheet 11 and the release sheet 16 is provided to cover the adhesive layer 15, but the present invention is not limited thereto. The other configuration can be suitably applied to the present invention, as long as the adhesive surface 13b has/exerts an adherence property only when being adhered to an intended object surface, in the configuration where the substrate sheet 11 is applied to the product using after-mentioned method for producing the 3D image formation object. For example, it is possible to adopt an adhesive layer which exerts an adherence property by undergoing a predetermined treatment such as humidification, heating, and light irradiation. In stead of using such adhesive layer, it is also possible to apply adhesive agent or attach an adhesive sheet onto the surface of the substrate sheet 11 which is to be the adhesive surface 13b when being adhered to an object surface.

### (Method for Producing 3D Image Formation Object)

Next, a configuration where the abovementioned 3D image formation sheet is applied to the product using the 3D image forming method will be described with reference to the drawings.

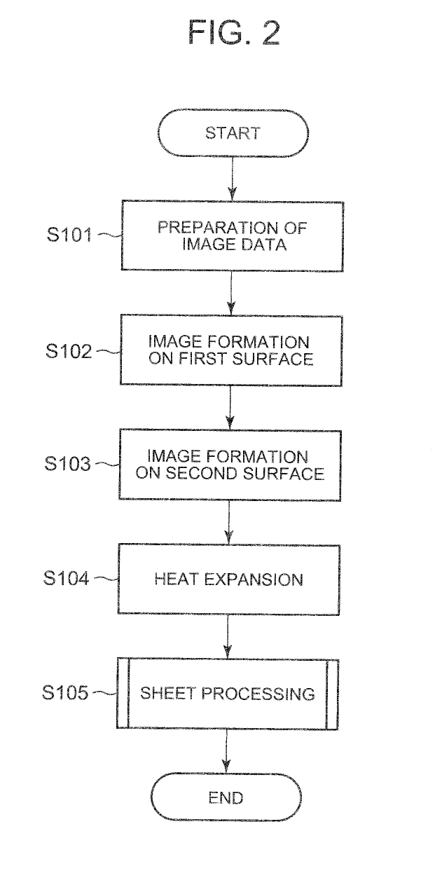

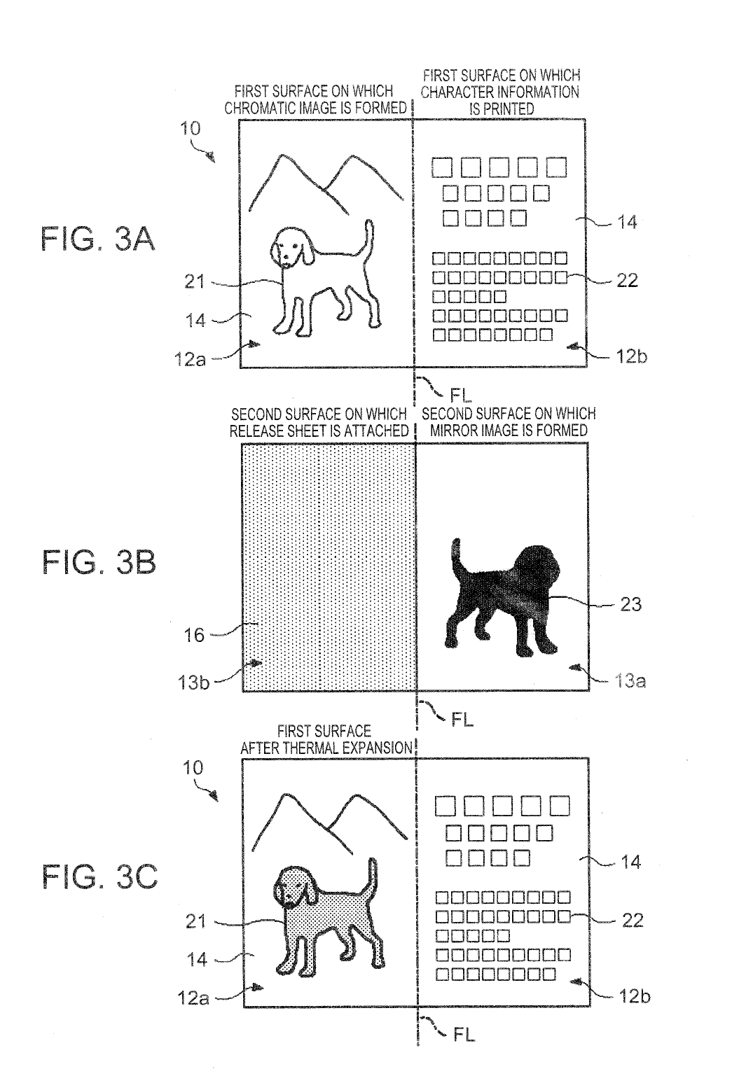

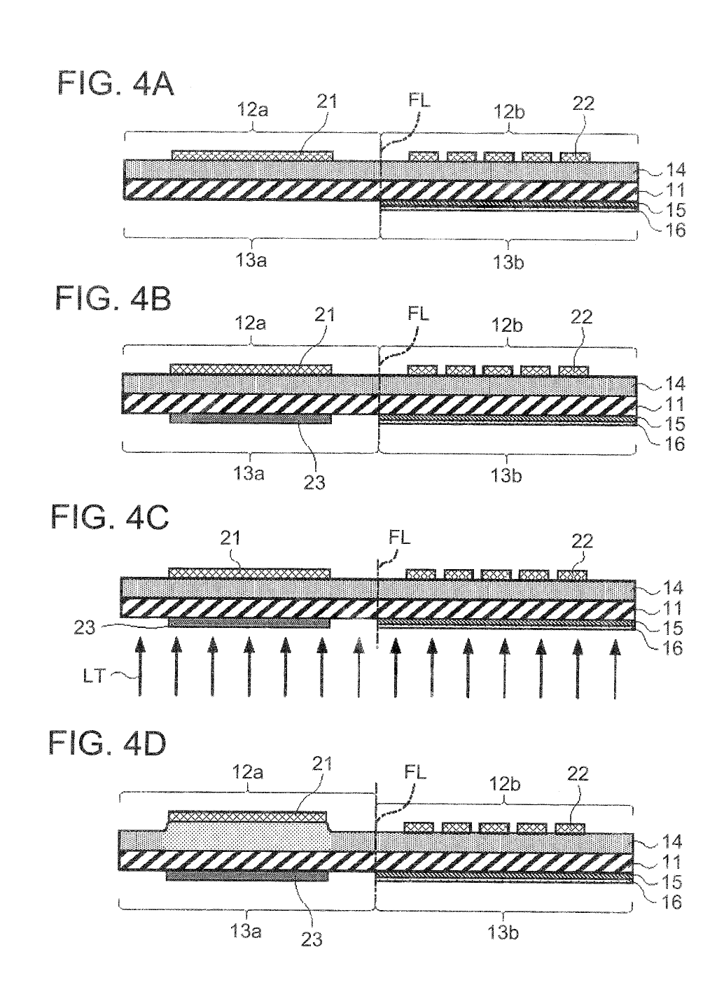

FIG. 2 is a flowchart illustrating an example of the method for producing the 3D image forming object according to this embodiment. FIGS. 3A to 3C are schematic top views illustrating a specific example in the method for producing the 3D image formation object according to this embodiment, and FIGS. 4A to 4D are schematic cross sectional views illustrating a specific example in the method for producing the 3D image formation object according to this embodiment. FIG. 3B illustrates the 3D image formation sheet which is rotated 180 degrees, namely, turned around upon the sheet processing line FL from the state shown in FIG. 3A. In FIGS. 3B and 3C, the release sheet 16, a mirror image 23, and a 3D image of a chromatic image 21 are conveniently indicated by hatching for simple illustration.

As schematically shown in FIG. 2 for example, the method for producing the 3D image formation object according to this embodiment includes an image data preparing step (S101), a first side image forming step (S102), a second side image forming step (S103), a heat expansion step (S104), and a sheet processing step (S105).

The image data preparing step (S101) firstly prepares: the 3D image formation sheet 10 having the abovementioned configuration; image data (hereinafter conveniently referred to as “chromatic image data”) of the arbitrary chromatic image which is an object of the 3D image to be formed on the 3D image forming surface 12a of the 3D image formation sheet 10; and data (hereinafter referred to as “character information data”) of the arbitrary character information to be printed on the character information printing surface 12b of the 3D image formation sheet 10. The adhesive layer 15 serves as the adhesive surface 13b of the 3D image formation sheet 10 is now covered with the attached release sheet 16 so as not to be exposed. In this description, the term “chromatic image” is used for convenience of explanation, but the image as an object of the 3D image can includes a monochrome image and a monotone image in addition to a color image. The character information is not an object of the 3D image. The character information can includes not only characters/letters but also images, figures, and signs as long as the information can be printed onto general printed materials. The character information can be information which includes no character/letter. In this description, the term “character information” is used for convenience of explanation.

Next, on the basis of the chromatic image data, with regard to the mirror image which is a reverse image of the chromatic image data, image data (hereinafter conveniently referred to as “mirror image data”) in which a density of a black color component(s) is set correspondingly to a design or the like of the chromatic image data is created. Concretely, the density of the black color component of the mirror image is set on the basis of a height of a raised portion expected to arise according to the design or the like of the chromatic image. Data of the height of the raised portion of the chromatic image can be prepared separately from the chromatic image data to be used. In addition, in this embodiment, the black color component set in the mirror image is not limited to a black color as coloration. The component means material having a photothermal conversion property, by which thermal energy is generated by light absorption, which light including infrared light (far-infrared light in a broad sense). As the material having such photothermal conversion property, carbon black can be adopted, for example.

Then, as shown in FIGS. 3A and 4A, the first side image forming step (S102) forms (prints) the chromatic image 21 such as images of a dog and a mountain based on the chromatic image data prepared in the image data preparing step (S101) on the surface of the thermally expandable layer 14 of the 3D image forming surface 12a set in the first side of the 3D image formation sheet 10. At the same time of printing the chromatic image 21, or in the same step as this step, the character information of intended words is formed (printed), on the basis of the character information data prepared in the image data preparing step (S101), on the surface of the thermally expandable layer 14 of the character information printing surface 12b set on the first side of the 3D image formation sheet 10. For forming the chromatic image 21 and the character information 22 on the first side of the 3D image formation sheet 10, various types of printing devices such as after-mentioned inkjet type, a laser type, and a thermal transfer type can be used.

Next, as shown in FIGS. 3B and 4B, the second side image forming step (S103) forms (prints) the mirror image 23 which is composed of a black color set to the predetermined density correspondingly to a position where the chromatic image 21 is formed on the 3D image forming surface 12a, using the mirror image data prepared in the image data preparing step (S101), directly on the surface of the substrate sheet 11 as the mirror image forming surface 13a set on the second side of the 3D image formation sheet 10. The mirror image 23 on the mirror image forming surface 13a of the 3D image formation sheet 10 is formed with ink, toner or the like which includes the black component such as carbon black. Also for forming the mirror image 23 on the second side of the 3D image formation sheet 10, various types of printing devices such as after-mentioned inkjet type, a laser type, and a thermal transfer type can be used.

Then, as shown in FIG. 4C, the heat expansion step (S104) irradiates the second side of the 3D image formation sheet 10 with light LT including infrared light uniformly from a light source such as a halogen lump and infrared lamp, in which sheet 10 the chromatic image 21 is formed on the 3D image forming surface 12a on the first side, the character information 22 is formed on the character information printing surface 12b on the same surface, and the mirror image 23 is formed on the mirror image forming surface 13a on the second side. Thereby the mirror image 23 formed on the mirror image forming surface 13a in the second side of the 3D image formation sheet 10 absorbs the irradiation light to generate thermal energy, and the thermal expandable layer 14 in the region corresponding to the mirror image 23 on the 3D image forming surface 12a is heated.

Thus, the microcapsules in the thermal expandable layer 14 in the corresponding region on the first side of the 3D image formation sheet 10 is heated with the thermal energy generated in the mirror image 23 on the second side, and the thermal expandable layer 14 selectively expands (foams) as shown in FIGS. 3C and 4C. Since the thermal energy to be generated in the mirror image 23 is defined correspondingly to the density of the black color component which composes the mirror image 23, the thermal expandable layer 14 is raised to the predetermined height, and thereby the 3D image of the chromatic image 21 is formed.

Next, in the sheet processing step (S105), a specific configuration of a product is completed after the following processing.

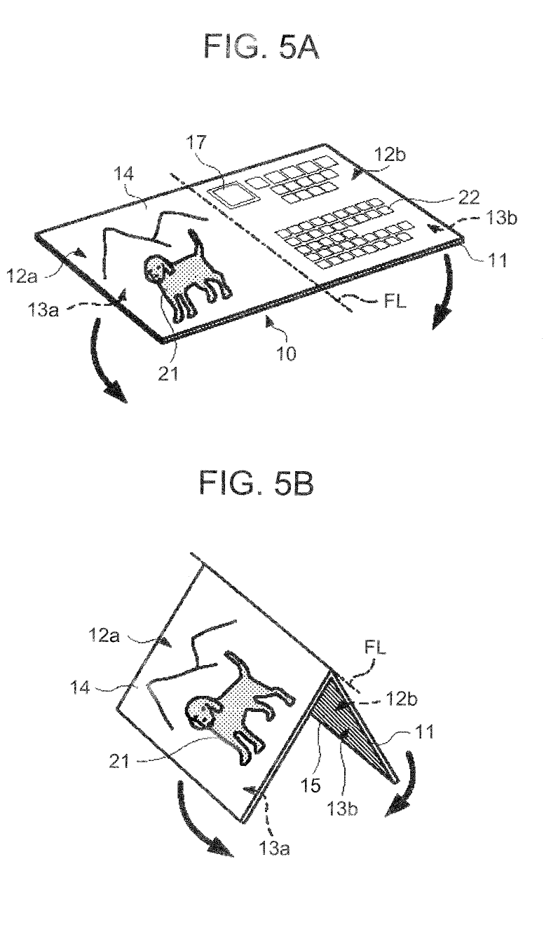

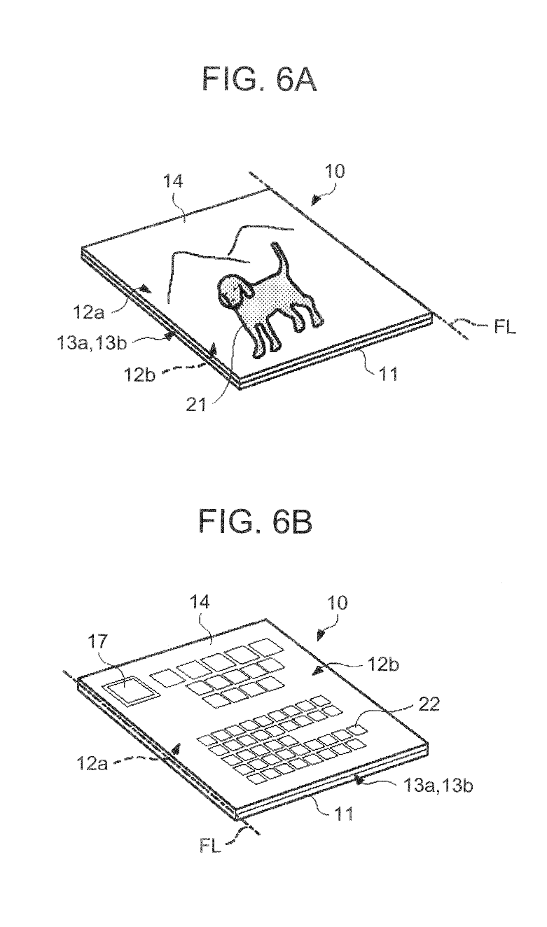

FIGS. 5A and 5B are schematic views illustrating sheet processing steps in the method for producing the 3D image formation object according to this embodiment, and FIGS. 6A and 6B are schematic perspective views illustrating a configuration where the 3D image formation sheet is applied to the product, in which sheet a 3D image is formed by the method for producing the 3D image formation object according to this embodiment.

The sheet processing step (S105) firstly removes the release sheet 16 attached to the adhesive surface 13b in the second side of the 3D image formation sheet 10, on which sheet 10 the abovementioned 3D image is formed, so that the adhesive layer 15 is exposed. Then, the 3D image formation sheet 10 is processed to be folded to make a mountain fold along the sheet processing line FL as shown in FIGS. 5A and 5B. By making the mirror image forming surface 13a and the adhesive surface 13b on the second side stick together so that they face each other, the mirror image forming surface 13a and the adhesive surface 13b are adhered to each other by adhesion force of the adhesive layer 15.

As shown in FIGS. 6A and 6B, this completes the product which includes the 3D image forming surface 12a in the first side (upper side in FIG. 6A), on which surface 12a the 3D image of the chromatic image 21 is formed, and further includes the character information printing surface 12b in the second side (upper side in FIG. 6B), on which surface 12b the character information 22 is formed. According to this embodiment, by forming the character information 22 including an address, name and announcement/message on the character information printing surface 12b of the product and putting a stamp thereon as shown in FIGS. 6A and 6B, the product (3D image formation object) such as a picture postcard and greeting card which is generally treated as a mail can be produced, and this can propose a novel configuration where the 3D image formation sheet 10 in which the 3D image is formed is applied to the product. Incidentally, the character information 22 such as an address and name can be handwritten on the character information printing surface 12b after completing the product such as a picture postcard and greeting card.

According to the method for producing the 3D image formation object and the 3D image formation sheet of this embodiment, in addition to the advantage that the novel configuration where the 3D image formation sheet 10 including the formed 3D image is applied to the product can be proposed, the following advantage can be obtained.

When producing a picture postcard or greeting card including the 3D image on the first side thereof using the thermally expandable sheet preformed in a postcard size, a general method prints the chromatic image on the first side on which the thermal expandable layer is formed, prints the mirror image composed of a black color component(s) on the second side, and applies heat to produce foam so as to form the 3D image of the chromatic image on the first side. In this case, however, since the mirror image is printed on the second side, the character information including an address, name and announcement/message of a picture card or greeting card cannot be printed thereon. A possible solution of such problem is, for example, after forming the 3D image of the chromatic image on the first side, attaching a seal to cover at least the mirror image printed on the second side, and printing the intended character information. In this case, however, the thermally expandable sheet has an increased thickness (one (1) millimeter or more, for example) because the 3D image is already formed on the first side thereof. For this reason, there has been a problem that a general-purpose printer which is popularized for family use or the like cannot feed paper smoothly for printing.

As an another solution, there has been known a method for printing a gray image with an ink having a photothermal conversion property on the first side on which the thermal expansion layer is formed, applying heat to produce foam to form the 3D image on the first side, and then printing the chromatic image by a professional-use inkjet printer using a non-contact type printing technique to color the 3D image. In this case, however, there has been a problem that manufacturing processes are complicated, and higher manufacturing cost is needed.

In contrast, according to the 3D image formation object producing method and the 3D image formation sheet of this embodiment, the chromatic image 21 and the character information 22 are printed on the first side of the 3D image formation sheet 10 formed to have the area twice that of a postcard, the mirror image 23 is printed on the second side, and then heat expansion is performed, as described above. In this way, the 3D image of the chromatic image 21 can be formed on the first side of the 3D image formation sheet 10, and after that, by folding the 3D image formation sheet 10 into two to make the folded second sides stick together, it becomes possible to obtain the product where the 3D image forming surface 12a on which the 3D image is formed and the character information printing surface 12b on which the character information 22 is formed has a front/back relationship. So according to this embodiment, it becomes unnecessary to adopt the complicated manufacturing method which uses the professional-use printer and takes a high cost, and it becomes possible to easily and successfully produce the product (the 3D image formation object) such as a picture postcard or greeting card using a general-purpose printer which is popularized for family use or the like.

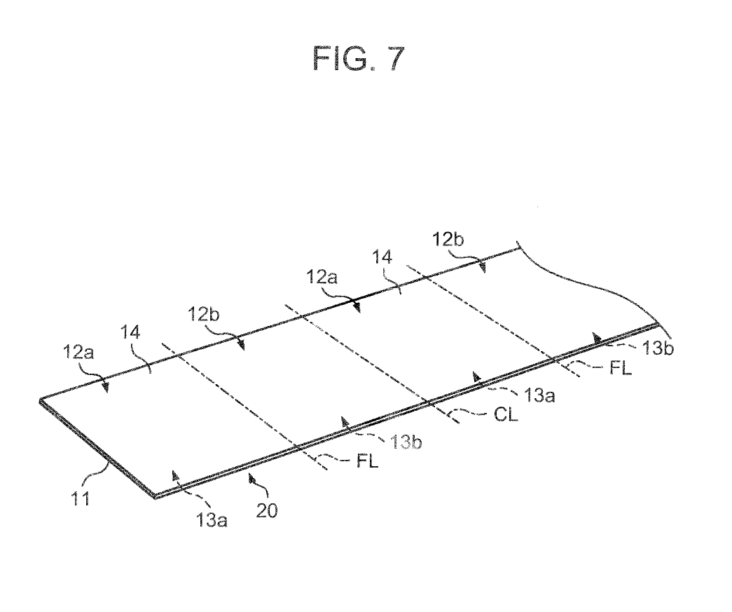

The first embodiment describes the case of using the 3D image formation sheet 10 (so-called “cut paper”) preformed in the size twice that of a picture postcard or greeting card, but the present invention is not limited thereto. As shown in FIG. 7, the present invention can use a continuous 3D image formation sheet 20 (so-called roll paper or long-size paper) where the 3D image formation sheets each having a unit size twice that of the picture postcard or greeting card, namely each corresponding to the 3D image formation sheet 10 shown in FIG. 1 or FIG. 5A, are repeatedly arranged in the following order: the 3D image forming surface 12a, the sheet processing line FL, the character information printing surface 12b, the sheet processing line CL, the 3D image forming surface 12a, the sheet processing line FL, the character information printing surface 12b, and the sheet processing line CL, etc. In this case, in an after-mentioned printing device, by cutting the 3D image formation sheet 20 along the sheet processing lines CL into the sheets each having the unit size after forming the image and the character information for the sheet of the unit size, namely after the first side image forming step (S102) or the second side image forming step (S103), or at an arbitrary timing after forming the 3D image or after the heat expansion step (S104), the sheet of the same size as that of the 3D image formation sheet 10 shown in this embodiment (FIG. 5A) can be obtained. FIG. 7 is a schematic configuration view illustrating a variation of the 3D forming sheet according to this embodiment.

### Second Embodiment

Next, a second embodiment of the 3D image formation object producing method and the 3D image formation sheet of the present invention will be described.

In the abovementioned first embodiment, there is described the case of preparing the 3D image formation sheet 10 having the size twice that of the completed produce such as a picture postcard or greeting card and folding the 3D image formation sheet 10 into two in the sheet processing step (S105). The second embodiment will describe the case of preparing the 3D image formation sheet 10 having the size three times that of the completed product and folding the 3D image formation sheet 10 into three.

### (3D Image Formation Sheet)

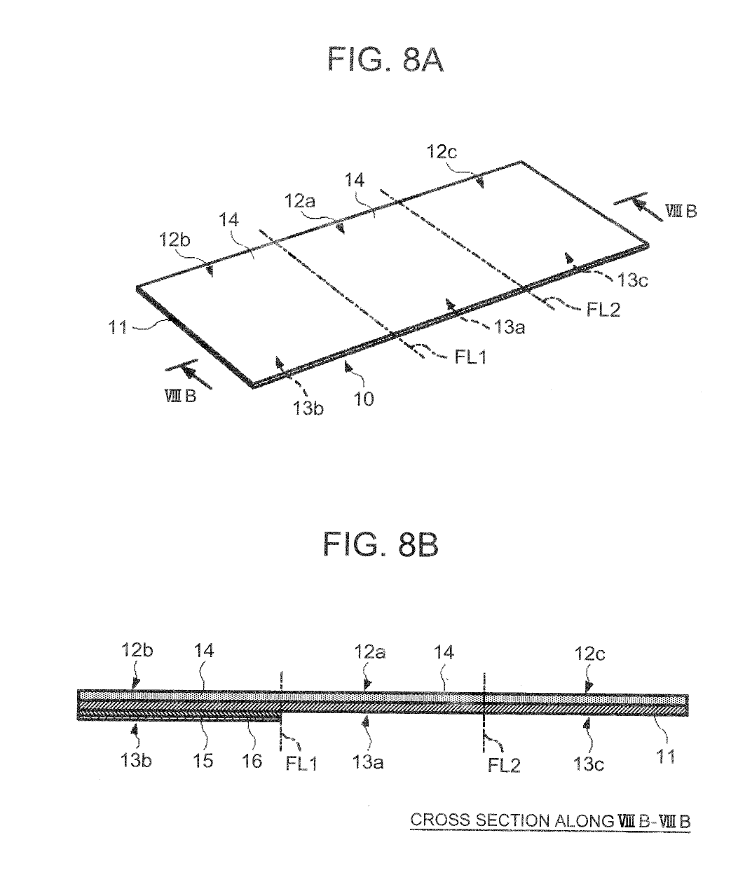

FIGS. 8A and 8B are schematic configuration views illustrating the second embodiment of the 3D image formation sheet of the present invention. FIG. 8A is a schematic perspective view illustrating the first side of the 3D image formation sheet according to this embodiment, and FIG. 8B is a schematic cross sectional view illustrating a cross section along the line VIIIB-VIIIB shown in FIG. 8A. In the following descriptions, same references are used for configurations and methods same as those of the first embodiment and their descriptions are simplified.

As shown in FIGS. 8A and 8B, sheet processing lines FL1, FL2 divide each of the first side and the second side of the substrate sheet 11 into three, which sheet 11 is included in the 3D image formation sheet 10 according to the second embodiment of the present invention. Concretely, as shown in FIGS. 8A and 8B for example, the character information printing surface 12b is set in a left area on a first side (upper side) of the substrate sheet 11 in the drawing, the 3D image forming surface 12a is set in a central area on the same surface, and an image/character printing surface 12c is set in a right area on the same surface. In addition, the adhesive surface 13b is set in a left area on a second side (lower side) of the substrate 11 in the drawing, the mirror image forming surface 13a is set in a central area on the same surface, and an image/character forming surface 13c is set in a right area on the same surface. In other words, similarly to the case of the first embodiment, the 3D image forming surface 12a and the mirror image forming surface 13a have a front/back relationship via the substrate sheet 11, and the character information printing surface 12b and the adhesive surface 13b have a front/back relationship via the substrate sheet 11. In addition, in this embodiment, the image/character printing surface 12c and the image/character printing surface 13c have a front/back relationship via the substrate sheet 11.

The region which serves as the character information printing surface 12b (or the adhesive surface 13b) and the region which serves as the 3D image forming surface 12a (or the mirror image forming surface 13a) are adjacent to each other across the sheet processing line FL1 as a borderline, have the same shape as each other, and have a line symmetrical relationship with respect to the sheet processing line FL1. In addition, the region which serves as the 3D image forming surface 12a (or the mirror image forming surface 13a) and the region which serves as the image/character printing surface 12c (or the image/character printing surface 13c) are adjacent to each other across the sheet processing line FL2 as a borderline, have the same shape as each other, and have a line symmetrical relationship with respect to the sheet processing line FL2. Thus, the substrate sheet 11 to be used in the 3D image formation sheet 10 of this embodiment has the area three times that of the 3D image forming surface 12a (or the mirror image forming surface 13a), the character information printing surface 12b (or the adhesive surface 13b), or the image/character printing surface 12c (or the image/character printing surface 13c).

As shown in FIG. 8A, in the whole area (in the 3D image forming surface 12a, the character information printing surface 12b, and the image/character printing surface 12c) on the first side of the substrate sheet 11, a thermally expandable layer 14 is disposed. On the adhesive surface 13b in the second side of the substrate sheet 11, the adhesive layer 15, and the release sheet 16 which covers the adhesive layer 15 are disposed.

In the 3D image formation sheet 10 of this embodiment having the abovementioned configuration, an arbitrary chromatic image is formed on the 3D image forming surface 12a on the first side of the substrate sheet 11, and a monochrome image corresponding to the chromatic image is formed on the mirror image forming surface 13a in the second side. In addition, arbitrary character information is formed (printed) on the character information printing surface 12b on the first side of the substrate sheet 11, and on the adhesive surface 13b on the second side, the adhesive layer 15 covered with the release sheet 16 is preformed. Furthermore, arbitrary image and/or character information is formed (printed) on the image/character printing surface 12c on the first side of the substrate sheet 11 and on the image/character printing surface 13c in the second side of the substrate sheet 11.

Next, a configuration where the abovementioned 3D image formation sheet is applied to the product using the 3D image forming method will be described with reference to the above mentioned first embodiment and the drawings.

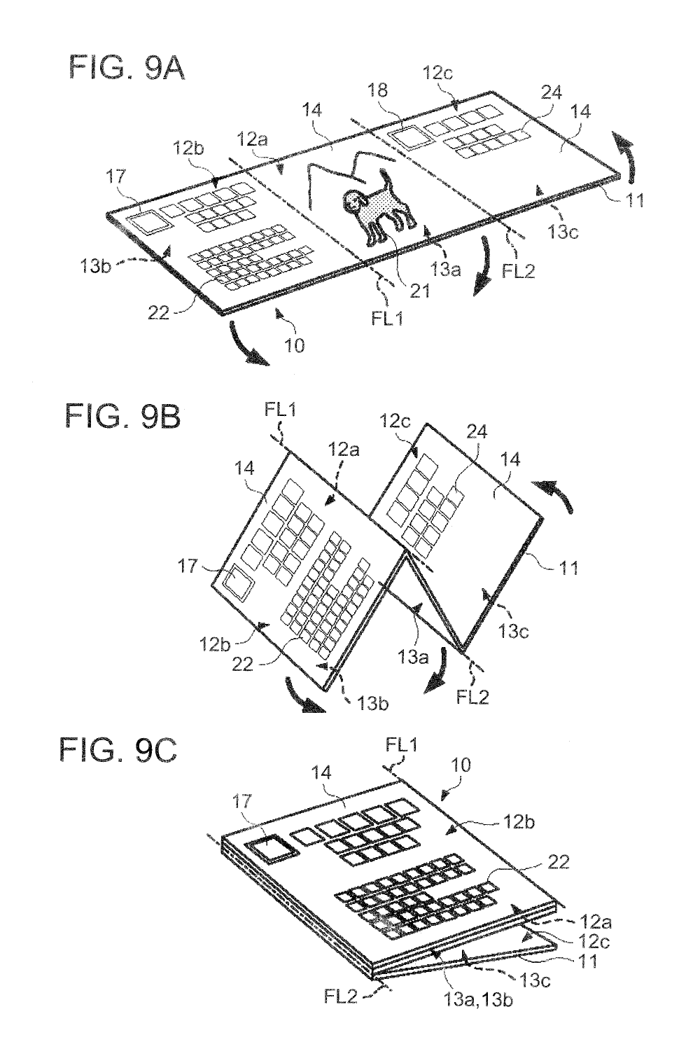

FIGS. 9A to 9C are schematic views illustrating sheet processing steps in the 3D image forming method according to this embodiment. In the following descriptions, descriptions of the same method as the first embodiment are simplified.

The 3D image formation object producing method according to this embodiment forms an intended 3D image and character information on the 3D image formation sheet 10 by executing the same steps (S101 to S104) as those of the 3D image forming method (see FIG. 2) described in the first embodiment.

Concretely, as shown in the flowchart of FIG. 2, the image data preparing step (S101) prepares: the 3D image formation sheet 10 having the above-mentioned configuration; image data (chromatic image data) of the chromatic image which is an object of the 3D image to be formed on the 3D image forming surface 12a; data (character information data) of the character information to be printed on the character information printing surface 12b; and data (hereinafter conveniently referred to as “image/character data”) of image and/or character information to be printed on the image/character printing surfaces 12c, 13c. The image and/or character information to be printed on the image/character printing surfaces 12c, 13c is not an object of the 3D image similarly to the character information to be formed on the abovementioned character information printing surface 12b, and includes an image and/or characters to be printed onto general printed materials. In addition, in the image data preparing step (S101), on the basis of the chromatic image, with regard to the mirror image of the chromatic image, image data (mirror image data) in which a predetermined density is set is created.

Then, as shown in FIG. 9A for example, the first side image forming step (S102) forms (prints) the chromatic image 21 based on the chromatic image data on the 3D image forming surface 12a in the first side of the 3D image formation sheet 10, and forms (prints) the character information 22 based on the character information data on the character information printing surface 12b, similarly to the case of the first embodiment. At this point, an image and/or the character information based on the image/character data is formed (printed) on the image/character printing surface 12c.

Next, the second side image forming step (S103) forms (prints) the mirror image 23 based on the mirror image data directly on the mirror image forming surface 13a in the second side of the 3D image formation sheet 10, similarly to the case of the first embodiment. At this point, an image and/or character information based on the image/character data is formed (printed) directly onto the image/character printing surface 13c.

Then, the heat expansion step (S104) uniformly irradiates the second side of the 3D image formation sheet 10 with light including infrared light from a light source such as a halogen lump and infrared lamp, in which sheet 10 the chromatic image 21 is formed on the 3D image forming surface 12a on the first side, the character information 22 is formed on the character information printing surface 12b, the image and/or character information 24 is formed on the image/character printing surface 12c, the mirror image 23 is formed on the mirror image forming surface 13a on the second side, and the image and/or the character information is formed on the image/character printing surface 13c. Thereby the mirror image 23 formed on the second side of the 3D image formation sheet 10 absorbs the irradiation light to generate thermal energy, and the thermal expandable layer 14 in the region corresponding to the mirror image 23a is heated and selectively expand. Thus, the 3D image of the chromatic image is formed.

Next, the sheet processing step (S105) firstly removes the release sheet 16 to expose the adhesive layer 15, which sheet 16 is attached to the adhesive surface 13b on the second side of the 3D image formation sheet 10 in which the 3D image is formed by the abovementioned 3D image forming method. Then, as shown in FIGS. 9A and 9B, the 3D image formation sheet 10 is processed to make a mountain fold along the sheet processing line FL, and the mirror image forming surface 13a and the adhesive surface 13b on the second side are made stick together so that they face each other and adhered to each other. Moreover, the 3D image formation sheet 10 is processed to make a valley fold along the sheet processing line FL2, and the sheet 10 is folded so that the 3D image forming surface 12a and the image/character printing surface 12c face each other.

As shown in FIG. 9C, this completes the product which includes the character information printing surface 12b on a first side (upper side in FIG. 9C), on which surface 12b the character information 22 is formed, and the 3D image forming surface 12a on the second side (lower side in FIG. 9C), on which surface 12a the 3D image of the chromatic image 21 is formed, and in which the 3D image formation sheet 10 is folded so that the 3D image forming surface 12a faces the image/character printing surface 12c. According to this embodiment, by forming the character information 22 including an address and name to be written in a initial half of a double postcard and announcement/message on the character information printing surface 12b of the product and putting a stamp 17 thereon as shown in FIG. 9C, and by forming the character information 24 including an address and name to be written in a reply half of a double postcard on the image/character printing surface 12c and putting a stamp 18 thereon, the product (3D image formation object) such as a double postcard which is generally treated as a mail can be produced. According to this embodiment, a novel configuration where the 3D image formation sheet 10 including the formed 3D image is applied to the product can be proposed. In this case, the character information printing surface 12b is used as the initial half, and the image/character printing surface 12c is used as the reply half. Incidentally, the character information 22, 24 including an address, name and announcement/message can be handwritten on the character information printing surface 12b or the image/character printing surfaces 12c, 13c after completing the product such as a double postcard. Moreover, in this embodiment, the present invention can be applied as a greeting card, message card, and invitation card, and so on by changing the character information, image and the like to be formed on the character information printing surface 12b or the image/character printing surfaces 12c, 13c. Furthermore, according to this embodiment, similarly to the case of the first embodiment, it is unnecessary to adopt a complicated high-cost manufacturing method using a special printer such as a professional one, and it becomes possible to easily and successfully process the product (3D image formation object) such as a double postcard and a greeting card using a general-purpose printer which is popularized for family use or the like.

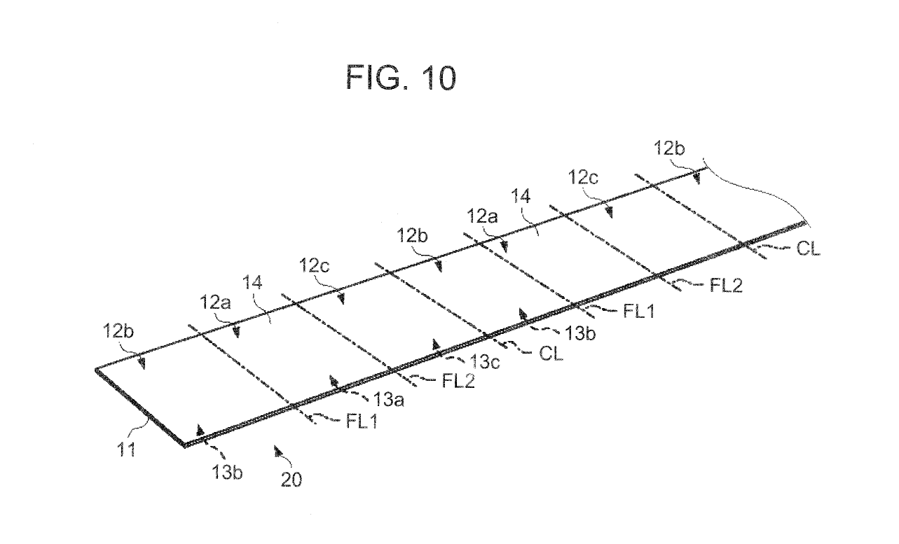

The second embodiment describes the case of using the 3D image formation sheet 10 (so-called “cut paper”) preformed in the size three times that of a picture postcard or the like, but the present invention is not limited thereto. Similarly to the variation of the first embodiment (see FIG. 7), as shown in FIG. 10, the present invention can use a continuous 3D image formation sheet 20 (so-called roll paper or long-size paper) where the 3D image formation sheets each having a unit size three times that of the postcard or the like, namely each corresponding to the 3D image formation sheet 10 shown in FIG. 9A are repeatedly arranged in the following order: the character information printing surface 12b, the sheet processing line FL1, the 3D image forming surface 12a, the sheet processing line FL2, the image/character printing surface 12c, the sheet processing line CL, the character information printing surface 12b, the sheet processing line FL1, the 3D image forming surface 12a, the sheet processing line FL2, the image/character printing surface 12c, and the sheet processing line CL, etc. Also in this case, similarly to the case of the first embodiment, using in an after-mentioned printing device, by cutting the 3D image formation sheet 20 along the sheet processing lines CL into the sheets each having the unit size after forming the image and the character information for the sheet of the unit size, namely after the first side image forming step (S102) or the second side image forming step (S103), or at an arbitrary timing after forming the 3D image or after the heat expansion step (S104), the sheet of the same size as that of the 3D image formation sheet 10 shown in this embodiment (FIG. 9A) can be obtained. FIG. 10 is a schematic configuration view illustrating a variation of the 3D forming sheet according to this embodiment.

### Third Embodiment

Next, the third embodiment of the 3D image formation object processing method and the 3D image formation sheet of the present invention will be described.

In the abovementioned first and second embodiments, there is described the case of preparing the 3D image formation sheet 10 having the size (unit size) twice or three times that of the completed produce such as a picture postcard, double postcard or greeting card, and folding the 3D image formation sheet 10 so as to be half or one-third of the original sheet 10 in the sheet processing step (S105), so that the product is made from the 3D image formation sheet 10 of a single item. The third embodiment will describe a configuration where the 3D image formation sheets 10 each having a predetermined unit size are combined or jointed to obtain a novel product.

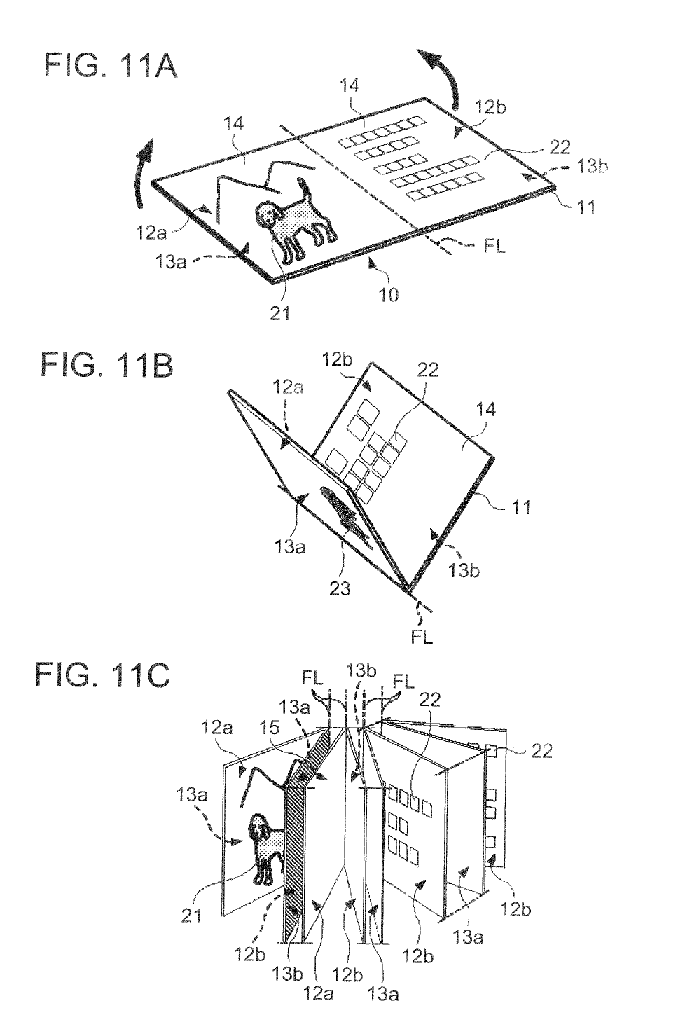

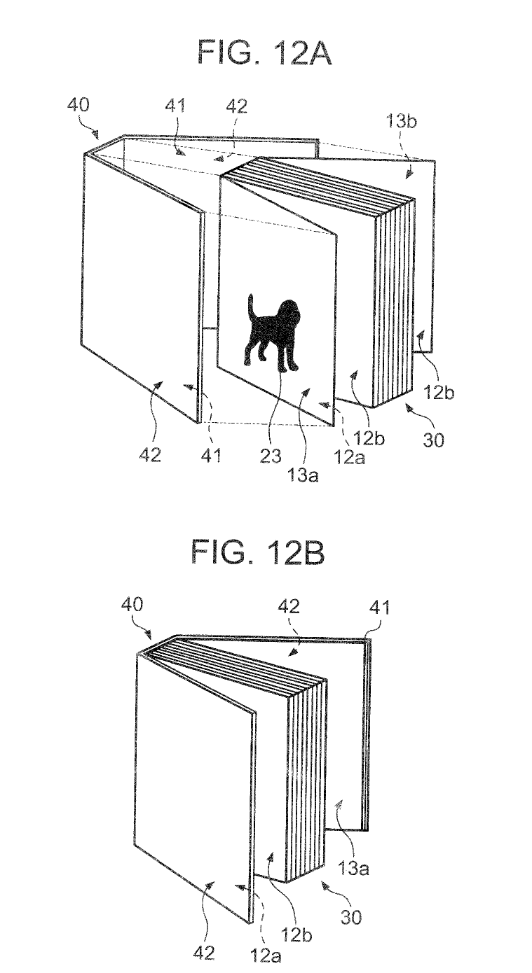

FIGS. 11 and 12 are schematic views illustrating sheet processing steps in the 3D image forming method according to the third embodiment. In the following descriptions, same references are used for configurations and methods same as those of the first and second embodiments and their descriptions are simplified.

In the third embodiment of the present invention, similarly to the case of the first embodiment, a plurality of 3D image formation sheets 10 are prepared, each sheet 10 having a unit size twice that of the completed product as shown in FIG. 11A. On the 3D image forming surface 12a on the first side of each 3D image formation sheet 10, an intended chromatic image 21 is formed (printed), and on the character information printing surface 12b, intended character information 22 is formed (printed). Then, after forming (printing) the mirror image 23 which is a reverse image of the chromatic image 21 on the mirror image forming surface 13a on the second side of each 3D image formation sheet 10, the second side is uniformly irradiated with light including infrared light, and thereby the thermally expandable layer 14 of the 3D image forming surface 12a selectively expands to form the 3D image of the chromatic image 21.

Then, as shown in FIGS. 11A and 11B, the sheet processing step (S105) processes each 3D image formation sheet 10, on which the 3D image is formed, to make a valley fold along the sheet processing line FL so that the 3D image forming surface 12a and the image/character printing surface 12c on the first side face each other. Next, after removing the release sheet 16 attached to the adhesive surface 13b on the second side of each 3D image formation sheet 10 to expose the adhesive layer 15, the step (S105) arranges the plurality of 3D image formation sheets 10, each of which is folded to become half of the original size, so that directions (or folding position) of the sheet processing lines FL are aligned with one another as shown in FIG. 11C, and make the adhesive surface 13b of one 3D image formation sheet 10 and the mirror image forming surface 13a of another neighboring 3D image formation sheet 10 stick together so that they face each other and adhered to each other. This makes it possible to produce an assembly (sheet assembly) in which each mirror image forming surface 13a and each adhesive surface 13b of the plurality of 3D image formation sheets 10 are adhered to each other, as shown in FIG. 12A.

After that, as shown in FIG. 12A, an inner surface 41 of an exterior material 40 is adhered to the mirror image forming surface 13a and the adhesive surface 13b of the 3D image formation sheet 10, which surfaces are both end faces of the sheet assembly 30, and a spine (thickness portion where the sheet processing lines are disposed) of the sheet assembly 30, so that these end surfaces and spine are covered. According to this embodiment, it becomes possible to produce a product (3D image formation object) such as a picture book, book/magazine and stationery which is produced by applying a surface 42 of the exterior material 40 attached to the sheet assembly 30 as a front cover of a book, as shown in FIG. 12B, and this can propose a novel configuration where the 3D image formation sheet 10 on which the 3D image is formed is applied. Incidentally, the character information 22 to be formed on the character information printing surface 12b can be handwritten on the same surface after completing the product such as a book/magazine and stationery.

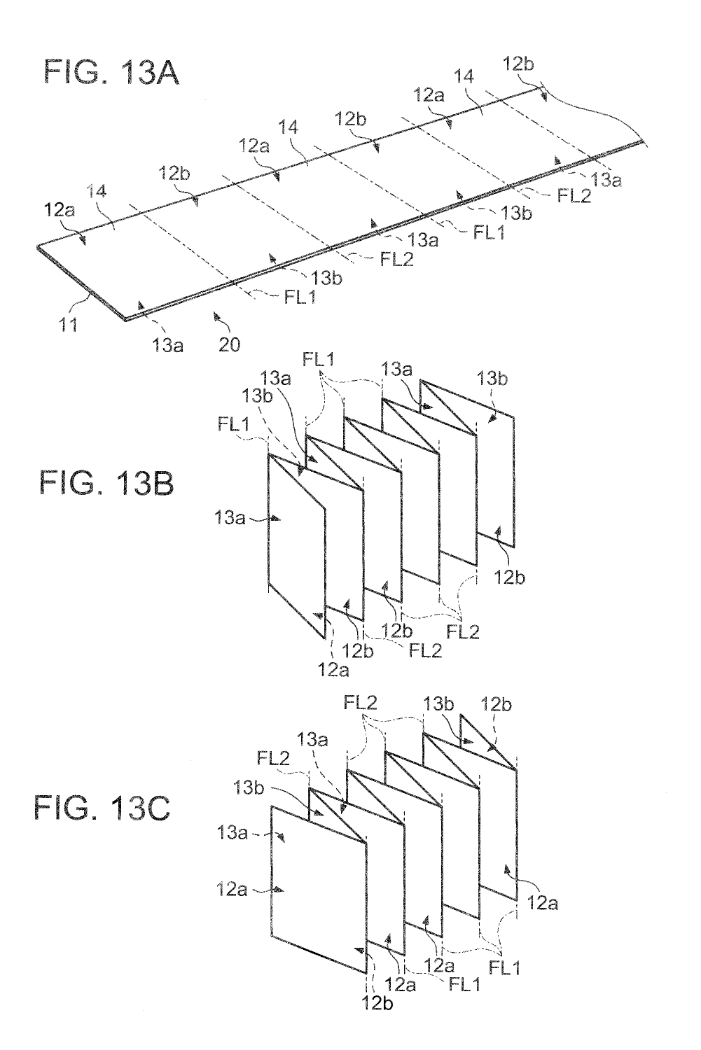

The third embodiment describes the case of using the plurality of 3D image formation sheets 10 (so-called “cut paper”) preformed in the size twice that of the completed product, but the present invention is not limited thereto. Similarly to the variation of the first embodiment (see FIG. 7), as shown in FIG. 13A, the present invention can use a continuous 3D image formation sheet 20 (so-called roll paper or long-size paper) where the 3D image formation sheets each having the abovementioned unit size, namely each corresponding to the 3D image formation sheet 10 shown in FIG. 11A are repeatedly arranged in the following order: the 3D image forming surface 12a, the sheet processing line FL1, the character information printing surface 12b, the sheet processing line FL2, the 3D image forming surface 12a, the sheet processing line FL1, the character information printing surface 12b, and the sheet processing line FL2, etc.

In this case, the following 3D image forming method is executed using an after-mentioned printer. This method firstly forms the image and the character information for each unit size repeatedly on the first side of the continuous 3D image formation sheet 20, and after that, performs heat expansion with respect to the whole of the 3D image formation sheet 20 to form the 3D image. Then, the method removes the release sheet 16 attached to each adhesive surface 13b on the second side of the 3D image formation sheet 20 to expose the adhesive layer 15. Next, as shown in FIG. 13B, the method makes a valley fold along each sheet processing line FL1 so that the 3D image forming surface 12a and the neighboring character information printing surface 12b face each other, and makes a mountain fold along the sheet processing line FL2 to make the mirror image forming surface 13a and the neighboring adhesive surface 13b on the second side stick together so that face each other and adhered to each other. This makes it possible to obtain an equivalent configuration to the assembly (sheet assembly) 30 of the 3D image formation sheets 10 shown in this embodiment (see FIG. 2A).

Moreover, in the case of adopting the roll paper or long-size paper as the 3D image formation sheet, the following 3D image forming method can be executed. This method firstly forms the image and the character information for each of the abovementioned unit size repeatedly on the first side of the continuous 3D image formation sheet 20, and after that, performs heat expansion with respect to the whole of the 3D image formation sheet 20 to form the 3D image. Then, the method removes the release sheet 16 attached to each adhesive surface 13b on the second side of the 3D image formation sheet 20 to expose the adhesive layer 15. Next, as shown in FIG. 13C, the method makes a mountain fold along the sheet processing line FL1 to make the mirror image forming surface 13a and the neighboring adhesive surface 13b on the second side stick together so that they face each other and adhered to each other, and makes a valley fold along each sheet processing line FL2 so that the character information printing surface 12b and the neighboring 3D image forming surface 12a on the first side face each other. This makes it possible to obtain the assembly (sheet assembly) 30 of the 3D image formation sheets equivalent to that of this embodiment (see FIG. 12A). This method makes it possible to produce a product (3D image formation object) such as a picture book, book/magazine and stationery where the 3D image forming surface 12a and the character information printing surface 12b, which surfaces are both end faces of the sheet assembly 30, are applied as a front cover of a book, and this can propose a novel configuration where the 3D image formation sheet 20 on which the 3D image is formed is applied to the product. FIG. 13 is a schematic configuration view illustrating a variation of the 3D image formation sheet according to this embodiment.

### (3D Image Forming Device)

Next, a 3D image forming device enables executing the 3D image forming method using the abovementioned 3D image formation sheet will be described. In the following description, the case of producing the product such as a picture postcard and greeting card using the 3D image formation sheet 10 shown in the first embodiment will be described.

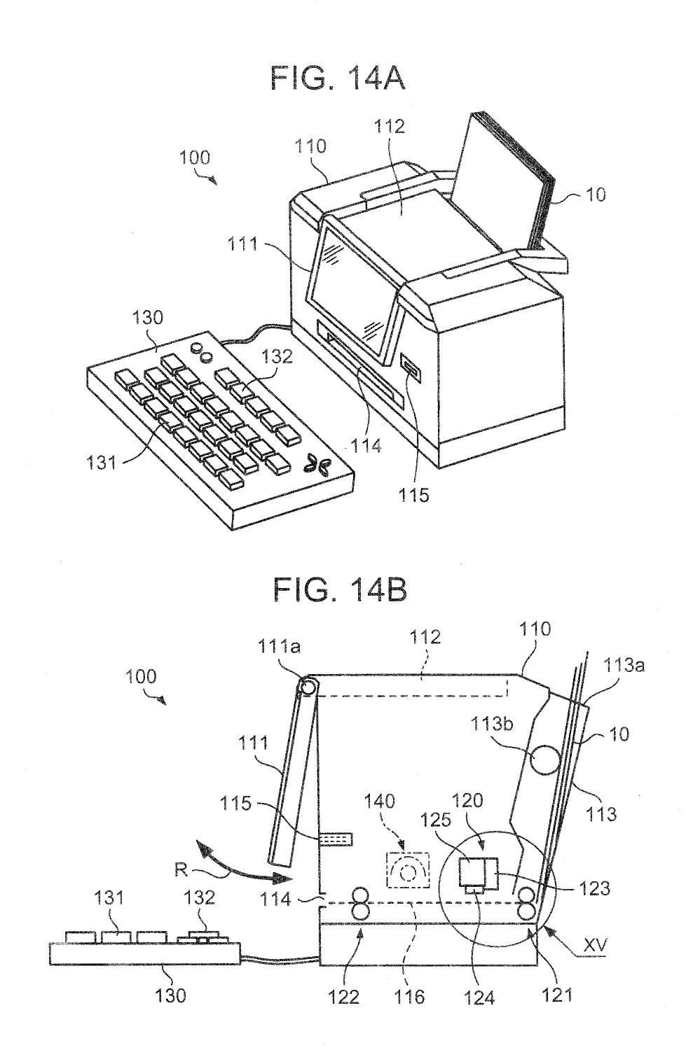

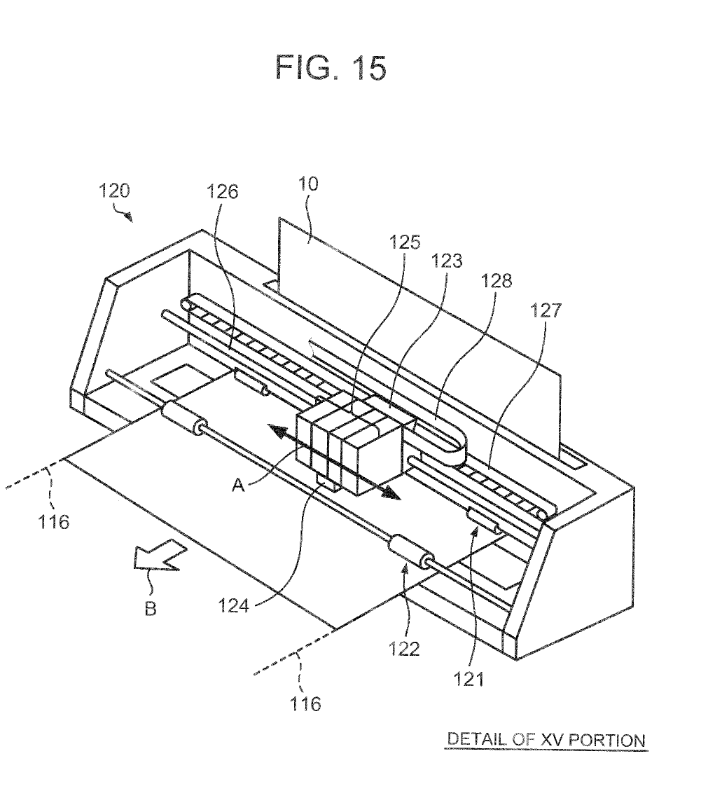

FIGS. 14A and 14B are schematic configuration views illustrating an example of a printing device which can be applied as the 3D image forming device by which the 3D image forming method of the present invention can be executed. FIG. 14A is a perspective view illustrating a schematic configuration of the printing device, and FIG. 14B is an inner cross sectional view illustrating a schematic configuration of the printing device shown in FIG. 14A. FIG. 15 is a schematic configuration view illustrating an example of a print mechanism section in the printing device to which the 3D image forming method of the present invention can be applied. FIG. 15 is a perspective detail view of a portion indicated with “XV” in FIG. 14B.

Among the steps in the 3D image forming method according to the abovementioned embodiments, at least image data preparing step (S101), the first side image forming step (S102), and the second side image forming step (S103) can be executed by a printing device 100 shown in FIG. 14. The printing device 100 which can be applied to the 3D image forming method of the present invention includes an inkjet type printer which is equipped with a word processor function and specifically has a device body 110 and a keyboard 130 as shown in FIGS. 14A and 14B, for example.

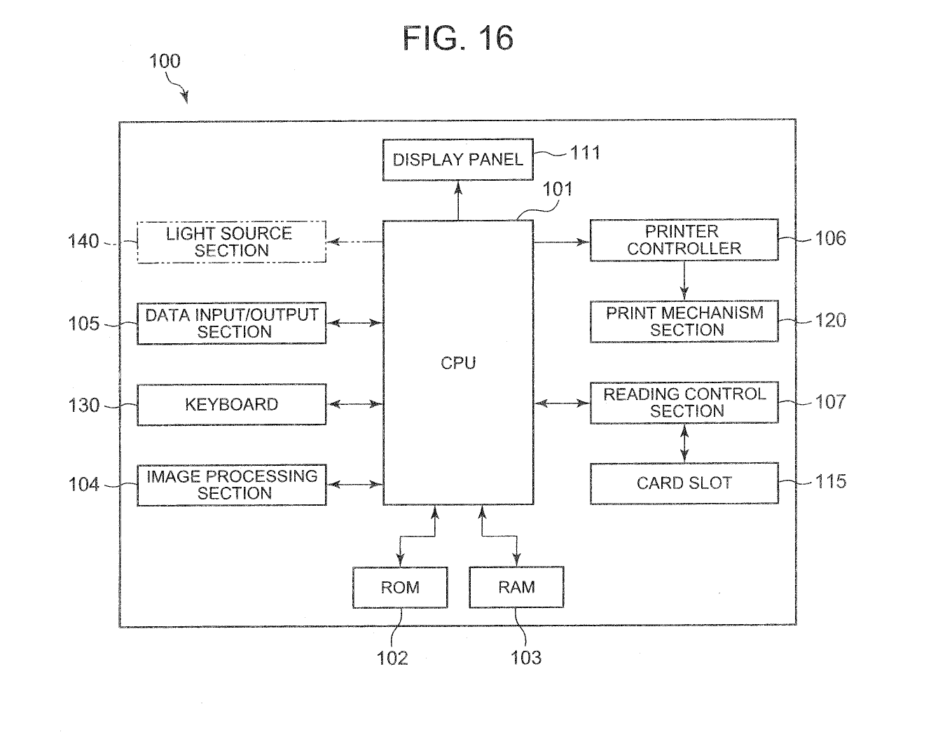

The device body 110 has a box-shaped chassis as shown in FIGS. 14A and 14B for example, and includes a display panel 111, a display panel housing section 112, a sheet feeding tray 113, a sheet ejecting port 114, a card slot 115, a print mechanism section 120 (see FIG. 15), and a control section (illustration omitted, see FIG. 16).

The display panel 111 is a liquid crystal display for example, and mounted to the device body 110 rotatably around a hinge section 111a as an axis, provided at one side of the display panel 111, in a direction indicated with arrow R in FIG. 14B. The display panel 111 displays data and/or character information input from the keyboard 130, a menu screen necessary for various types of settings, various types of images such as a photo image retrieved via a memory card, and various pieces of data to be used in the printing device. The display panel housing section 112 is disposed in an upper side section (upside in the drawing) of the device body 110, and makes the display panel 111 rotate to house the same when the printing device 100 is in an unused state.

The sheet feeding tray 113 is disposed in a back surface portion (right side in the drawing) of the device body 110. The 3D image formation sheets 10 each having the predetermined unit size as above mentioned enter one by one, or in a state that multiple sheets are superposed, into the sheet feeding tray 113 from an opening section 113a disposed in an upper portion. In the sheet feeding tray 113, there is disposed a pickup roller 113b which sends the 3D image formation sheets 10, which sheets 10 are housed in a superposed state, one by one to the print mechanism section 120 in the device body 110.

The sheet ejecting port 114 is disposed in a lower part of a front surface portion (left side in the drawing) of the device body 110, and enables the 3D image formation sheet 10 to be output to the outside of the device body 110, on which sheet 10 printing is executed by the print mechanism section 120 in the device body 110. The card slot 115 is disposed in the front surface of the device body 110. By inserting a memory card (illustration omitted) into the card slot 115, writing and/or reading of image data and the like is performed.

Moreover, as shown in FIG. 14B, there is disposed a sheet conveying path 116 in the device body 110, which path 116 serves as a conveyance guide for the 3D image formation sheets 10 sent one by one by the pickup roller 113b in the sheet feeding tray 113. In the middle of the sheet conveyance path 116, the print mechanism section 120 is disposed, which is an inkjet type for example. A pair of feeding rollers 121 and a pair of ejecting rollers 122 for conveying the 3D image formation sheets 10 are disposed at the both sides of the print mechanism section 120 near the sheet feeding tray 113 and near the sheet ejecting port 114 respectively.

As shown in FIG. 15, the print mechanism section 120 includes a carriage 123 which reciprocates in the direction indicated with arrow A, which direction is perpendicular to the sheet conveyance path 116. The carriage 123 has a printing head 124 and an ink cartridge 125 for executing printing. The ink cartridge 125 is composed of cartridges each individually housing one of color inks of yellow, magenta, cyan, and black, or a cartridge of a unit item including ink chambers of the respective color inks, for example. To each of the cartridges, or to each of the ink chambers, the printing head 124 which has a nozzle for discharging the respective color inks is connected. In this embodiment, as a black ink housed in the ink cartridge 125, material having an excellent photothermal conversion property such as carbon black is used.

The carriage 123 is held by a guide rail 126 so as to be able to reciprocate as mentioned above. By driving a drive belt 127 attached in the print mechanism section 120 in a parallel direction with an extending direction of the guide rail 126, the printing head 124 and the ink cartridge 125 mounted in the carriage 123 reciprocate in the same direction as the carriage 123, namely in the direction indicated with arrow A, which is perpendicular to the sheet conveyance path 116.

To the printing head 124, printing data and/or a control signal(s) are sent from the control section provided in the device body 110 via a flexible cable 128. As described above, the 3D image formation sheets 10 are conveyed intermittently by the pair of feeding rollers 121 and the pair of the ejecting rollers 122 in a direction indicated with arrow B in FIG. 15. During a suspension period of intermittent conveyance of the 3D image formation sheets 10, the printing head 124 ejects an ink drop from a close position to the 3D image formation sheet 10, while reciprocating correspondingly to driving of the driving belt 127, to print the image and/or character information corresponding to the printing data on the first and second sides of the 3D image formation sheet 10. By repeating such intermittent conveyance of the 3D image formation sheets 10 and printing during the reciprocating motion of the printing head 124, an intended image (the abovementioned chromatic image 21 and mirror image 23) is formed (printed) on the 3D image forming surface 12a and the mirror image forming surface 13a of the 3D image formation sheet 10, and intended character information (the above-mentioned character information 22) is formed (printed) on the character information printing surface 12b. The 3D image formation sheet 10, in the predetermined region of which the predetermined image and character information is printed by the print mechanism section 120, is ejected from the sheet ejecting port 114 positioned in a downstream of the sheet conveyance path 116 to the outside of the device body 110 as shown in FIG. 14B.

The keyboard 130 is disposed in front (left side in the drawing) of a front surface of the device body 110, and includes data input keys 131 and functional keys 132 necessary for setting or executing various functions such as inputting, editing, and printing the character information when the device body 110 is used as the word processor.

Next, the control section included in the device body 110 of the printing device 100 will be described.

FIG. 16 is a function block diagram illustrating an example of the printing device which can be applied to the 3D image forming method of the present invention.

As shown in FIG. 16, the abovementioned printing device 100 includes: a central processing unit (hereinafter simply referred to as “CPU”) 101; a read-only memory (hereinafter simply referred to as “ROM”) 102 connected to the CPU 101; a random access memory (hereinafter simply referred to as “RAM”) 103; an image processing section 104; a data input/output section 105; a printer controller 106; a reading control section 107; the abovementioned display panel 111; a keyboard 130, and so on. The CPU 101, the ROM 102, the RAM 103, the image processing section 104, the data input/output section 105, the printer controller 106, and the reading control section 107 correspond to the control section of the printing device 100 which can be applied to the 3D image forming method of the present invention.

The ROM 102 stores a system program relevant to an operational control of the printing device 100. The CPU 101 executes the operational control of each section of the printing device 100 by transmitting instruction signals to the other functional blocks connected to the CPU 110 according to the system program. The RAM 103 temporarily stores various pieces of data and/or numeral values which are generated in the CPU 101 or the like during the operational control of the printing device.

The image processing section 104 executes the image data preparing step (S101) in the abovementioned 3D image forming method. Concretely, on the basis of the image data (chromatic image data) of the chromatic image as an object of the 3D image, which data is retrieved from the outside of the device body 110 via the card slot 115 or the like to be displayed on the display panel 111, or stored in the RAM 103 or the like, the image processing section 104 creates the image data (mirror image data) of the mirror image as a reverse image of the chromatic image. At this point, the image processing section 104 sets the density of the black color component of the mirror image included in the mirror image data on the basis of the height of the raised portion expected to arise according to the design or the like of the chromatic image.

The data input/output section 105 has an interfacing function to make printing commands relevant to the image data (chromatic image data, mirror image data) and/or the character information data between the printing device 100 and an external communication device (illustration omitted) such as a personal computer of note type or desktop type. The printer controller 106 is connected to the print mechanism section 120, and controls an ink ejecting state of the printing head 124 on the basis of the image data and/or the character information data which is an object of printing. The printer controller 106 also controls the reciprocating motion of the carriage 123 to which the printing head 124 is attached, and controls driving of the pair of the feeding rollers 121 and the pair of the ejecting rollers 122 to control conveyance of the 3D image formation sheet 10 toward the sheet ejecting port 114. The reading control section 107 is connected to the card slot 115, and reads the image data and/or the character information data from the memory card (illustration omitted) inserted into the card slot 115 to transmit the read data to the CPU 101, the image processing section 104, and the like.

According to the printing device 100 having such configuration, it becomes possible to form (print) the predetermined chromatic image and mirror image based on the image data and the predetermined character information based on the character information data in the predetermined regions of the first and second sides of the 3D image formation sheet supplied from the sheet feeding tray 113.

This configuration example describes the case that the printing device 100 has a single-sided printing function. Specifically, in the first side image forming step (S102) of the abovementioned 3D image forming method, the 3D image formation sheet 10 is fed so that the first side thereof faces the printing head 124 to print the intended chromatic image and character information in the predetermined region (the 3D image forming surface, the character information printing surface) on the first side. In the second side image forming step (S103) of the same method, the 3D image formation sheet 10 is turned over and fed so that the second side thereof faces the printing head 124 to print the mirror image corresponding to the chromatic image on the first side in the predetermined region (mirror image forming surface) on the second side.

The printing device which can be applied to the 3D image forming method of the present invention is not limited to the above example, and includes a printing device which has sheet-turning-over mechanism sections for a double-sided printing at the both sides of the print mechanism section 120 of the device body 110 shown in FIGS. 14B and 15, near the sheet feeding tray 113 and near the sheet ejecting port 114 respectively. Specifically, the printing device can convey the 3D image formation sheet 10 in a reverse direction to the direction indicated with arrow B to bring the sheet 10 toward the sheet feeding tray 113 again, in which sheet 10 the printing mechanism section 120 completes printing on the first side (or second side) and which sheet 10 has been conveyed toward the sheet ejecting port 114, and turns over the sheet 10 near the sheet feeding tray 113 to enable printing on the second side (or the first side) on the sheet 10 to eject the same from the sheet ejecting port 114. This can save steps of manually turning over the 3D image formation sheet 10, which has been ejected after single-sided printing, and putting the 3D image formation sheet 10 in the sheet feeding tray 113 again, in the case of printing the image and/or the character information on both sides of the thermally expandable sheet 10.

The abovementioned configuration example describes the case that the image processing section 104 provided in the control section of the printing device 100 executes the image data preparing step (S101) of the 3D image forming method according to the above-mentioned embodiments, but the present invention is not limited thereto. It is also possible to adopt a configuration where the image data preparing step is executed in an external communication device such as a personal computer connected to the printing device 100 via the data input/output section 105, the image data (chromatic image data and mirror image data) of the chromatic image and the mirror image thereof is transmitted to the printing device 100, and the chromatic image and the mirror image thereof is formed (printed) in the predetermined region of the 3D image formation sheet 10.

Moreover, the abovementioned configuration example describes the case that the printing device 100 executes the image data preparing step (S101), the first side image forming step (S102), and the second side image forming step (S103) among the steps of the 3D image forming method according the embodiments, but the present invention is not limited thereto. Specifically, it is possible to adopt a configuration where in the internal configuration of the printing device 100 shown in FIG. 14B, as indicated with a two-dot chain line, a light source section 140 such as a halogen lamp is disposed at the side of the print mechanism section 120 near the sheet ejecting port 114, and above or below the sheet conveying path 116 (or the 3D image formation sheet 10). The light source 140 emits a predetermined amount of light according to conveyance of the 3D image formation sheet 10 on the basis of an instruction from the CPU 101 as indicated with a two-dot chain line in FIG. 16, for example.

In such configuration, the second side of the 3D image formation sheet 10 is irradiated with uniform light, in which sheet 10 the predetermined chromatic image is formed on the first side and the mirror image is formed on the second side through the image data preparing step (S101), the first side image forming step (S102) and the second side image forming step (S103). This makes the thermally expandable layer 14 of the 3D image formation sheet 10 expand so that the raised portion has the predetermined height, and thereby the heat expansion step (S104) for forming the 3D image is executed. In other words, the printing device 100 of a unit item can execute a series of the steps (S101 to S104) in the abovementioned 3D image forming method in the lump.

The abovementioned embodiments describe the case of adopting the thermally expandable sheet in which the thermally expandable layer 14 is formed on the first side of the substrate sheet 11, as the 3D image formation sheets 10, 20, but the present invention is not limited thereto. The present invention can be applied in another case as long as it can produce the product (3D image formation object) where the 3D image of the intended chromatic image is formed on the 3D image forming surface 12a set in the first side of the substrate sheet 11, the intended character information 22 is formed on the character information printing surface 12b, the substrate sheet 11 is folded into two, and the two second sides of the substrate sheet 11 are adhered to each other so that the 3D image forming surface 12a including the 3D image and the character information printing surface 12b including the character information have a front/back relationship and expose outward. Accordingly, the 3D image forming method of the present invention is not limited to the abovementioned method by which the thermally expansion layer selectively expand. For example, a 3D image forming method can execute inkjet printing or the like with UV ink including ultraviolet curable ink directly on the first side of the substrate sheet, performing sequential lamination of the ink layer, and curing the same. In this case, in the image data preparing step (S101) of the 3D image forming method, in stead of the processing for creating the mirror image data on the basis of the chromatic image data, processing for creating cross section data of respective layers at the time of forming (printing) the 3D image of the chromatic image is executed on the basis of height data of the raised portion included in the chromatic image data, for example. In this method, since the 3D image of the chromatic image is formed (printed) in the first side image forming step (S102), the heat expansion step (S104) in the abovementioned 3D image forming method is omitted.

Having described and illustrated the principles of this application by reference to preferred embodiments, it should be apparent that the preferred embodiment may be modified in arrangement and detail without departing from the principles disclosed herein and that it is intended that the application be construed as including all such modifications and variations insofar as they come within the spirit and scope of the subject matter disclosed therein.

What is claimed is:

1. A method for producing a three dimensional (3D) image formation object comprising:
setting a first region and a second region with a first processing line as a borderline between the first and second regions on a first side of a 3D image formation sheet;
forming a first image for obtaining a 3D image on the first region and printing information on the second region; and
processing the 3D image formation sheet to fold the sheet along the first processing line and adhering a third region and a fourth region to each other, the third region being on a second side of the 3D image formation sheet and corresponding to the first region, and the fourth region being on the second side and corresponding to the second region.

2. The method according to claim 1, wherein
the 3D image formation sheet includes a continuous substrate sheet in which the first and second regions are repeatedly set in a predetermined order, and
at an arbitrary timing at least before the folding processing of the 3D image formation sheet, the substrate sheet is cut into a unit size each including the first and second regions, and then the 3D image formation object is produced.

3. The method according to claim 2 further comprising:
forming a thermally expandable layer on a first side of the substrate sheet in the 3D image forming sheet,
before the folding processing of the 3D image formation sheet, forming the first image on the thermally expandable layer in the first region, and printing the information on the second region,
forming a second image which is a mirror image of the first image using material having a photothermal conversion property in a corresponding region of the third region, which corresponding region corresponds to the first image,
irradiating the second side of the 3D image formation sheet with light so that thermal energy generated in the second image makes the thermally expandable layer selectively expand to form the 3D image.

4. The method according to claim 3 further comprising:
forming an adhesive layer in the fourth region and disposing a removable release sheet to cover the adhesive layer,
when processing the 3D image formation sheet to fold the sheet, removing the release sheet to expose the adhesive layer and adhering the third and fourth regions to each other via the adhesive layer.

5. The method according to claim 4, wherein the light includes infrared light.

6. The method according to claim 1 further comprising:
setting a second processing line as a borderline which divides the first side into the first region except a fifth region, and the fifth region, on the first side of the 3D image formation sheet;
forming intended information in the fifth region; and
processing the 3D image formation sheet to fold the sheet along the second processing line so that the first region except the fifth region, and the fifth region, face each other.

7. The method according to claim 6, wherein
the 3D image formation sheet is made from a continuous substrate sheet in which the first region except the fifth region, the second region, and the fifth region are repeatedly set in a predetermined order, and
at an arbitrary timing at least before the folding processing of the 3D image formation sheet, the substrate sheet is cut into a unit size each having the first region except the fifth region, the second region, and the fifth region, and then the 3D image formation object is produced.

8. The method according to claim 1 further comprising:
forming a plurality of processing objects by the folding processing along the first processing lines by which the first and second regions face each other,
arranging the processing objects so that directions of the first processing lines are aligned with one another, and adhering the third and fourth regions of the neighboring processing objects to each other, and
producing the 3D image formation object including an assembly in which the processing objects exist continuously.

9. The method according to claim 1 further comprising:
repeatedly setting the first and the second regions with the first processing lines as the borderlines in the predetermined order;
folding the 3D image formation sheet along the first processing lines to make mountain folds and valley folds alternately so that the first and second regions face each other; and
adhering the third and fourth regions to each other to produce the 3D image formation object including an assembly in which a state that the neighboring first and second regions face each other and a state that the neighboring first and second regions have a front/back relationship are alternately repeated.

10. The method according to claim 1 further comprising:
forming a thermally expandable layer on the first side of the 3D image forming sheet,
before the folding processing of the 3D image formation sheet, forming the first image on the thermally expandable layer in the first region and printing the information on the second region,
forming a second image which is a mirror image of the first image using material having a photothermal conversion property in a corresponding region of the third region, which corresponding region corresponds to the first image,
irradiating the second side of the 3D image formation sheet with light so that thermal energy generated in the second image makes the thermally expandable layer selectively expand to form the 3D image.

11. The method according to claim 10, wherein the light includes infrared light.

12. The method according to claim 1, wherein
forming an adhesive layer in the fourth region and disposing a removable release sheet to cover the adhesive layer,
when processing the 3D image formation sheet to fold the sheet, removing the release sheet to expose the adhesive layer and adhering the third and fourth regions to each other via the adhesive layer.

13. A three dimensional (3D) image formation sheet comprising:
a substrate sheet;
a first region which is set on a first side of the substrate sheet and in which a first image for obtaining a 3D image is formed;
a second region which is set on the first side of the substrate sheet and in which information is printed;
a third region which is on a second side of the substrate sheet and corresponds to the first region; and
a fourth region which is on the second side of the substrate sheet, corresponds to the second region, and in which an adhesive layer is formed, wherein
the first and second regions are set across a first processing line as a borderline.

14. The 3D image formation sheet according to claim 13, wherein the substrate sheet includes the first and second regions which are repeatedly set in a predetermined order, and further includes a cutting line for cutting the substrate sheet into a unit size including the first and second regions.

15. The 3D image formation sheet according to claim 14, wherein
the substrate sheet includes a thermally expandable layer on the first side, and
the 3D image of the first image is formed by forming the first image on the thermally expandable layer in the first region, forming the second image which is a mirror image of the first image from material having a photothermal conversion property in a corresponding region of the third region, which corresponding region corresponds to the first image, irradiating the second side of the substrate sheet with light so that thermal energy generated in the second image makes the thermally expandable layer selectively expand.

16. The 3D image formation sheet according to claim 14, wherein
the first and second regions are repeatedly set in a predetermined order on the substrate sheet, which sheet is processed to be folded along the first processing line so that a state in which the neighboring first and second regions face each other and a state in which the neighboring first and second regions have a front/back relationship are repeated.

17. The 3D image formation sheet according to claim 13 further comprising:
a fifth region on the first side of the substrate sheet, in which region information is printed, wherein
the first region except the fifth region, and the fifth region, are set across a second processing line as a borderline.

18. The 3D image formation sheet according to claim 17, wherein the substrate sheet includes the first region except the fifth region, the second region, and the fifth region, repeatedly set in a predetermined order, and further includes a cutting line for cutting the substrate sheet into a unit size including the first region except the fifth region, the second region, and the fifth region.

19. The 3D image formation sheet according to claim 13, wherein
the substrate sheet includes a thermally expandable layer on the first side, and
the 3D image of the first image is formed by forming the first image on the thermally expandable layer in the first region, forming the second image which is a mirror image of the first image from material having a photothermal conversion property in a corresponding region of the third region, which corresponding region corresponds to the first image, irradiating the second side of the substrate sheet with light so that thermal energy generated in the second image makes the thermally expandable layer selectively expand.

20. The 3D image formation sheet according to claim 13, wherein a removable release sheet is disposed in the fourth region so as to cover the adhesive layer.
